(19) United States
(12) Patent Application Publication
(10) Pub. No.: US 2019/0114598 A1
(43) Pub. Date: Apr. 18, 2019

(54) PAYMENT NETWORK AS A PLATFORM

(71) Applicant: Mastercard International Incorporated, Purchase, NY (US)

(72) Inventors: Shanthan Subramaniam, Baldwin Place, NY (US); Vitorino Jose Pereira Lopes, Brookfield, CT (US); Charlotte Ng, Scarsdale, NY (US)

(21) Appl. No.: 15/786,694

(22) Filed: Oct. 18, 2017

(51) Int. Cl. G06Q 20/02; G06Q 20/08; G06Q 20/40; G06Q 20/38; G06Q 30/06

(52) U.S. Cl. CPC G06Q 20/027; G06Q 20/0855; G06Q 30/06; G06Q 20/382; G06Q 20/405

(57) ABSTRACT

Systems and methods are provided for systems and methods are described herein for providing a payment network platform that facilitates the integration of third-party value added service provider applications (“VAS Apps”) within the infrastructure of a payment device network. The systems and methods for providing a payment network platform described herein enable a series of operations whereby VAS Apps are selectively and under the control of the payment network platform system server, provided access to transaction data for transactions being processed by and through the payment device network system for the purpose of performing supplemental processing of such transactions and thereby providing value added services to transacting network participants that have subscribed to the services provided by the VAS App.

### TECHNICAL FIELD OF THE DISCLOSURE

This patent application relates generally to the field of payment processing networks and, in particular, payment network infrastructure configured for integration with third-party applications and services.

### BACKGROUND OF THE DISCLOSURE

While there exist different types of computing network platforms today, such as booking services for taxis, e-commerce marketplaces for online merchants and mobile operating systems configured to provide a platform for mobile application developers, there does not exist a platform based on a payment card network configured to process transaction device payments and facilitate open integration of third-party applications and services into the payment device network ecosystem.

Large scale payment device networks, such as the payment device network provided by Mastercard International Incorporated of Purchase, N.Y., have connectivity in place linking multiple financial institutions and merchants globally. Payment device networks thus provide a network that facilitates the flow of payment transactions. Payment device network participants are generally interested in utilizing value added services in connection with payment transactions associated with the participants. At the same time, it is important that payment transactions be performed in a manner that meets the security interests of the various parties involved and other regulations.

Large scale payment device networks typically remain private and closed to external service providers. Moreover, to the extent that third-party applications have been utilized by network participants to manage and process payment transactions, these implementations typically involve deep and customized integration of the third-party application into the participant's computing systems. Further such integrations can require infrastructure providing a direct link between the third-party application systems and the participant's computing systems outside of the payment network itself, which can further complicate the system and associated transaction processing workflows.

As such, what is desired is a payment device network system that, in addition to its primary closed transaction processing function, is further configured to: 1) provide an open platform with which trusted third-party applications can integrate; and 2) facilitate offering services for which the network participants can subscribe to and efficiently utilize the payment network for other transaction flows and services.

It is with respect to these and other considerations that the disclosure made herein is presented.

### SUMMARY OF THE DISCLOSURE

Technologies are presented herein in support of a system and method for providing a payment network as a platform for integration of third-party applications and services.

According to a first aspect, a method for processing transactions conducted over a payment device network system and selectively facilitating supplemental processing of qualifying transactions by third-party value adding service applications. The method includes the step of providing, with a server computing device within the payment device network system, a communication connection between the system server and respective third-party value adding service applications (VAS apps) for transmitting transaction messages between the payment device network system and the VAS apps. In addition, the system server computing device provides a communication connection between the system server and a plurality of payment network participant systems for transmitting transaction messages between the payment device network system and the network participants. The method also includes the step of storing predefined usage criteria in a database that is accessible to the system server. More particularly, the predefined usage criteria specify conditions for performing supplemental processing of transactions on behalf of respective network participants using respective VAS apps. In addition, the method includes the steps of receiving a transaction request at the system server concerning a transaction associated with at least one network participant and determining, based on the transaction request and the predefined usage criteria, whether the transaction is qualified for supplemental processing by at least one of the VAS apps. In response to determining that the transaction is qualified for supplemental processing by the at least one VAS app, the method includes the steps of transmitting one or more data elements of the transaction request to the at least one VAS app for supplemental processing of the qualifying transaction and then receiving a result of the supplemental processing from the at least one VAS app. The method further comprises the step of forwarding the transaction request for further processing via the payment device network system in accordance with a default payment processing workflow. More specifically, the forwarded transaction request comprises the received transaction request and any result of pre-processing the transaction request by the at least one VAS app.

According to another aspect, a system for processing transactions carried out over a payment device network system and selectively facilitating supplemental processing of qualifying transactions by third-party value adding service applications is provided. The system comprises at least one processor of a payment device network system server and a communication interface for establishing electronic communication between the payment device network system server and a plurality of payment network participant systems, and between the payment device network system server and a plurality of third-party VAS apps. The system also includes a database that is accessible using the payment device network system server. In particular, the database includes predefined usage criteria specifying conditions for using respective VAS apps to process transactions on behalf of respective network participants. The system also includes a computer readable storage medium that is accessible by the at least one processor and includes software modules in the form of executable instructions.

In particular, the software modules include a transaction monitoring module that, when executed by the at least one processor, configures the payment device network system server to receive transaction requests concerning a transaction and determine whether the transaction request is a qualifying transaction according to the predefined usage criteria.

The software modules also include a transaction routing module that, when executed by the at least one processor, configures the payment device network system server to, in response to determining that the transaction request is a qualifying transaction, transmit one or more data elements of the transaction request to at least one VAS app for supplemental processing, and receive, from the at least one VAS app, a result of the supplemental processing of the qualifying transaction request. The transaction routing module further configures the payment device network system server to forward the transaction request for further processing of the transaction via the payment device network system in accordance with a default payment processing workflow. In particular, the forwarded transaction request comprises the received qualifying transaction request and any result of supplemental processing of transaction request by the at least one VAS app.

According to a further aspect, a non-transitory computer readable medium encoded with computer executable instructions is provided. The instructions, when executed by a system server computing device within a payment device network system, configure the system server to provide a communication connection between the system server and respective VAS apps for transmitting transaction messages between the payment device network system and the VAS apps. In addition, the instructions configure the system server computing device to provide a communication connection between the system server and a plurality of payment network participant systems for transmitting transaction messages between the payment device network system and the network participants. The instructions further configure the system server to store predefined usage criteria in a database that is accessible to the system server. More particularly, the predefined usage criteria specify conditions for performing supplemental processing of transactions on behalf of respective network participants using respective VAS apps.

In addition, the instructions configure the system server to receive a transaction request at the system server concerning a transaction associated with at least one network participant and determine, based on the transaction request and the predefined usage criteria, whether the transaction is qualified for supplemental processing by at least one of the VAS apps. In response to determining that the transaction is a qualified for supplemental processing by the at least one VAS app, the system server computing device system is also configured to transmit one or more data elements of the transaction request to the at least one VAS app for supplemental processing of the qualifying transaction and receive a result of the supplemental processing from the at least one VAS app. In addition, the instructions configure the system server computing device to forward the transaction request for further processing via the payment device network system in accordance with a default payment processing workflow. More specifically, the forwarded transaction request comprises the received transaction request and any result of pre-processing the transaction request by the at least one VAS app.

These and other aspects, features, and advantages can be appreciated from the accompanying description of certain embodiments of the invention and the accompanying drawing figures and claims.

### BRIEF DESCRIPTION OF THE DRAWINGS

FIG. 1 is a high-level diagram illustrating an exemplary multi-party transaction network system;

FIG. 2A is a block diagram illustrating an exemplary configuration of a payment network platform implemented using a payment device network system in accordance with one or more of the disclosed embodiments;

FIG. 2B is a block diagram illustrating an exemplary system server of the payment network platform in accordance with one or more of the disclosed embodiments;

FIG. 3 is a flow diagram showing a method for processing transactions carried out over a payment network and selectively facilitating supplemental processing of qualifying transactions by third-party value adding service applications in accordance with at least one embodiment disclosed herein;

FIG. 4A is a flow diagram showing a method for processing transactions carried out over a payment network and selectively facilitating supplemental processing of qualifying transactions by third-party value adding service applications in accordance with at least one embodiment disclosed herein;

FIG. 4B is a flow diagram showing a method for processing transactions carried out over a payment network and selectively facilitating supplemental processing of qualifying transactions by third-party value adding service applications in accordance with at least one embodiment disclosed herein; and

FIG. 5 is a flow diagram showing a method for processing transactions carried out over a payment network and selectively facilitating supplemental processing of qualifying transactions by third-party value adding service applications in accordance with at least one embodiment disclosed herein.

### DETAILED DESCRIPTION OF CERTAIN EMBODIMENTS OF THE DISCLOSURE

The methods and systems described herein relate to novel uses and extensions of a transaction device payment network system, such as a payment card payment system using the Mastercard® interchange (Mastercard is a registered trademark of Mastercard International Incorporated located in Purchase, N.Y., the assignee hereof). The Mastercard interchange is a proprietary communications standard promulgated by Mastercard International Incorporated for the exchange of financial transaction data over the Mastercard payment device network system between financial institutions who are customers of Mastercard International Incorporated for the purpose of electronically processing payment transactions.

By way of overview and introduction, various systems and methods are described herein for providing a payment network platform that integrates third-party value adding service applications (“VAS Apps”) into the infrastructure of a payment device network system and its existing transaction processing work flows. The terms “payment device network” and “payment device network system” are intended to refer to any payment device network, such as the aforementioned Mastercard payment device network, and the corresponding system for implementing the interchange standards, protocols and operations, as would be understood by those in the art. The term “payment network platform” is intended to refer to the payment device network system as enhanced using the systems and methods disclosed herein for facilitating the integration of VAS Apps into the existing payment device network system and provisioning of services to network participants through supplemental processing of transactions passing through the payment device network system.

Integration of VAS Apps into the payment network platform can be coordinated by a system server configured to implement various enrollment processes including enforcing compliance with appropriate security and technical requirements and establishing the necessary communications connections and interfaces enabling the VAS Apps to access aspects of the payment device network system under the control and management of the system server. The system server is further configured to provide a computer-accessible portal or “store front” through which network participants can review available VAS Apps and subscribe to respective VAS Apps and the associated services that they provide. In this regard, the store front can be the likes of an application store whereby terms and conditions can be reviewed and agreed upon by the network participants and whereby the participant consents to the use of certain data elements by the VAS Apps. The term “network participant” is intended to refer to the financial institutions who are customers of the payment device network system, however, it should be understood that network participants are not limited to such financial institutions and can include other direct or indirect users of the payment device network system including, for example and without limitation, merchants, payment account holders, payment device users, third-party service providers and other such individuals and entities.

The systems and methods for providing a payment network platform described herein enable a series of operations whereby VAS Apps are selectively, under the control of the system server, provided access to transaction data for transactions being processed by and through the payment device network system. The purpose of such access, according to one or more embodiments, is to perform supplemental processing of such transactions and thereby provide value added services to network participants that are parties to respective transactions and that have subscribed to the services provided by respective VAS Apps.

Accordingly, the exemplary payment network platform is configured to open the payment device network system in a secure and controlled manner, allowing for third-party service providers to, using respective computer implemented VAS Apps, extend services to subscribing network participants within the payment device network system. The payment network platform manages the engagement between the third-party service providers and the network participants connected to the payment device network system. In other words, the payment network platform provides the interface between the payment device network system infrastructure and the VAS App systems and can be managed as an all-inclusive platform providing services including but not limited to enforcing franchise rules, billing mechanics, certification of the onboarding of new VAS Apps and a store front which facilitates the enrollment of network participants to said services.

For example, in one exemplary implementation, the system server can monitor transaction messages that are “in flight” through the payment device network system and identify transactions that qualify for supplemental processing by a VAS App on behalf of a network participant. In response to identifying a qualifying transaction, the system server can selectively provide the VAS App with access to information included in the transaction message and thereby enable the VAS App to perform supplemental processing of the transaction on behalf of the network participant. In addition, the system server can be further configured to incorporate the result of supplemental processing by the VAS App into the transaction message, which can then be transmitted via the payment device network system for further processing according to the transaction-processing workflows that are implemented by the payment device network system for the particular type of transaction.

The integration of the VAS Apps into the payment device network system in accordance with the systems and methods described herein provide the technical advantage of enabling VAS Apps to perform supplemental processing on select transactions through direct communication with the system server existing within the payment device network and augmenting the transaction processing operations while the transactions are “in flight” through the payment device network system. The VAS App integration and the supplemental processing can also be performed without alteration of the existing payment device network system infrastructure that exists between the payment device network system and the network participants. The disclosed systems and methods can also achieve these benefits with only limited modification of the payment device network system's internal protocols for handling transaction messages in-flight therethrough. Moreover, the systems and methods described herein further provide the advantage of transforming, updating, and/or enhancing transaction messages based on the supplemental processing by a VAS App without disturbing the overall transaction processing workflow as perceived by other parties to the transaction. Moreover, the systems and methods described herein further provide the advantage of transforming, updating, and/or enhancing transaction messages based on supplemental processing by a VAS App in a way that can be utilized by a subscribing network participant and without altering the transaction message in a way that would interfere with subsequent processing of the transaction by any non-subscribing network participants.

Selectively providing a given VAS App with access to only relevant transaction information, as agreed to by a subscribing network participant, also allows the system server to enforce the necessary security and transaction processing protocols. Similarly, by reconciling the result of supplemental processing with the original transaction request using the system server prior to further processing of the transaction according to typical transaction processing workflows enables a given VAS App to provide services and augment the transaction processing process without compromising the security and integrity of the underlying transaction message.

It should be understood that any compiling and routing of transaction information or providing third-parties (e.g., VAS Apps) with access to transaction information, account information and the like by the payment network platform would be subject to applicable data privacy and data usages laws. It should also be understood that the network participants and associated account holders can also require authorization before the system server retrieves such information or provides it to other third-parties such as issuers, acquirers, merchants, VAS Apps and the like. Thus, it should be apparent that in the exemplary systems and methods described herein, depending on applicable laws and regulations, a network participant can utilize any VAS Apps on an opt-in basis, thereby consenting to the use of transaction information as well as any other personal information they might include, or on an opt-out basis.

The systems and methods for providing a payment network platform are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather, are provided as a representative embodiment and/or arrangement for teaching one skilled in the art one or more ways to implement the systems and methods. Accordingly, aspects of the present systems and methods can take the form of an entirely hardware embodiment, an entirely software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used herein are not intended to be limiting, but rather are to provide an understandable description of the systems and methods.

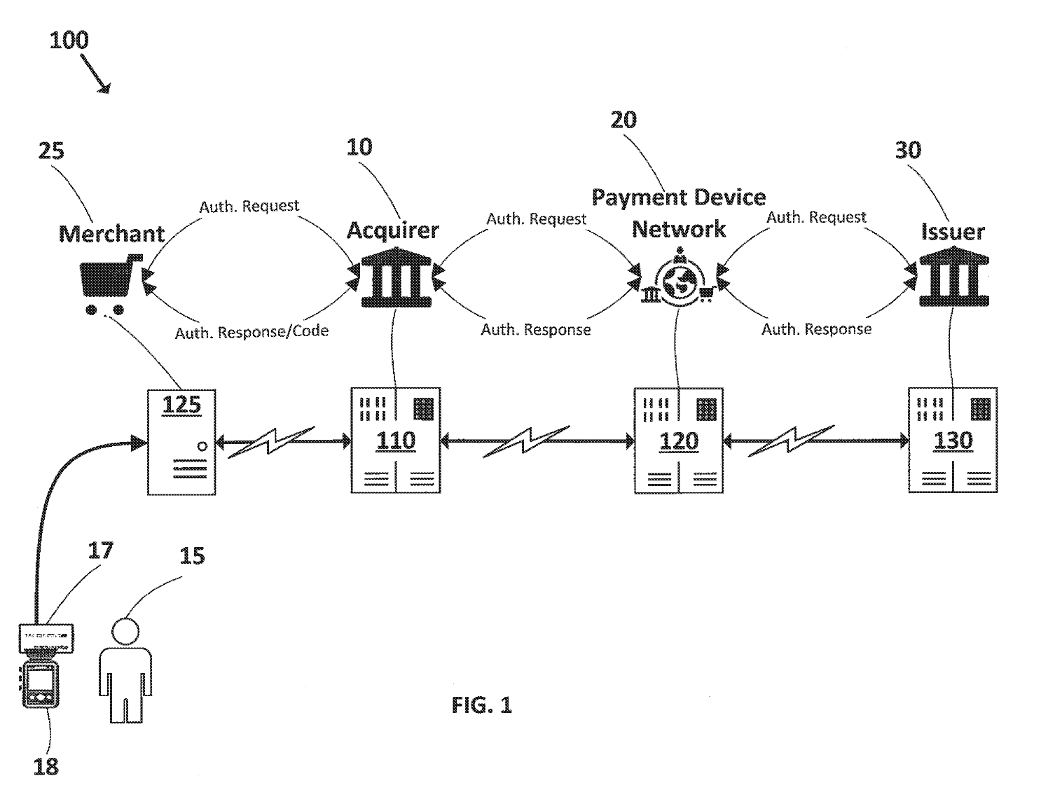

FIG. 1 shows a multi-party transaction system 100 for processing payment-by-device transactions, as is known and would be understood by those in the art. Four parties are typically involved in a transaction that is processed using the multi-party transaction system 100, including, an account holder 15, a merchant 25, an issuing financial institution (“issuer”) 30, an acquiring financial institution or acquirer bank (“acquirer”) 10 and the payment device network 20. Acquirer 10, typically, is a financial institution that, in this example, the merchant 25 has established an account with to accept payments made through the multi-party transaction system 100. Issuer 30, typically, is a financial institution that provides a payment device 17 to an account-holder 15, who uses the device to tender payment to a merchant 25 for purchases using an associated payment account.

As used herein, the term “payment device” 17 refers to any suitable transaction instrument, such as a physical credit card, a debit card, a membership card, a promotional card, a frequent flyer card, an identification card, a prepaid card, a gift card, and/or any other device that may hold payment account information, such as mobile phones, personal digital assistants (PDAs), and key fobs. “Payment device” is also intended to refer to digital transaction instruments that can be used to conduct transactions, including but not limited to digital wallets, virtual account numbers, and the like. Each of the parties involved in transactions processed using the multi-party transaction system 100 typically engages with the system 100 using a respective computing system or device. Accordingly, as shown, the exemplary multi-party transaction system 100 can include an acquirer computing system 110, a merchant payment processor system 125, and an issuer computing system 130 and the payment device network system 120 positioned between the acquirer and issuer computing systems.

FIG. 1 further illustrates the flow of transaction messages between the parties in an exemplary transaction authorization process, as would be understood by those in the field. More specifically, when the account-holder 15 tenders payment for a purchase with a payment device 17, the merchant 25 requests authorization from the acquirer 10 for the amount of the purchase. The request is usually performed through the use of a point-of-sale (POS) terminal 18, which reads the account holder's account information from the payment device 17 and the merchant payment processor system 125 communicates electronically with the acquirer computing system 110, either directly or via a payment processor/gateway (not shown).

The payment device network system 120 that is associated with the payment device network, enables the acquirer computing system 110 to communicate with the appropriate issuer computing system 130 to determine whether the account-holder's 15 payment account is in good standing and whether the purchase is covered by the account-holder's available funds or credit. Based on these determinations, the request for authorization can be declined or accepted. Upon authorizing the transaction (or declining) in view of the account information included in the authorization request, the issuer computing system 130 responds with an authorization response message that is passed back through the payment device network system 120 to the acquirer computing system 110. If the request is accepted, an authorization code is issued to merchant computing system 125 and an available funds or credit line of the account holder's account is decreased.

In addition to facilitating the intercommunication of network participants' respective computing systems for the purposes of transaction authorization, after a transaction is captured, the payment device network system 120 further facilitates the subsequent clearing and settlement of such transactions. More specifically, after a purchase has been made, a clearing process occurs to transfer additional transaction data related to the purchase among the parties to the transaction, such as the acquirer 10, payment device network 20 and issuer 30 and may be stored by any of the parties to the transaction. More specifically, during and/or after the clearing process, additional data, such as a time of purchase, a merchant name, a type of merchant, purchase information, account-holder account information, a type of transaction, information regarding the purchased item or service, and/or other suitable information, is associated with a transaction and transmitted between parties to the transaction, such as acquirer computing system 110, payment device network system 120, and issuer computing system 130. In addition, after a transaction is authorized and cleared, the transaction is settled among the merchant 25, acquirer 20, and issuer 30. Settlement refers to the transfer of financial data or funds among the merchant's account, the acquirer computing system 125 and the issuer computing system 130 related to the transaction.

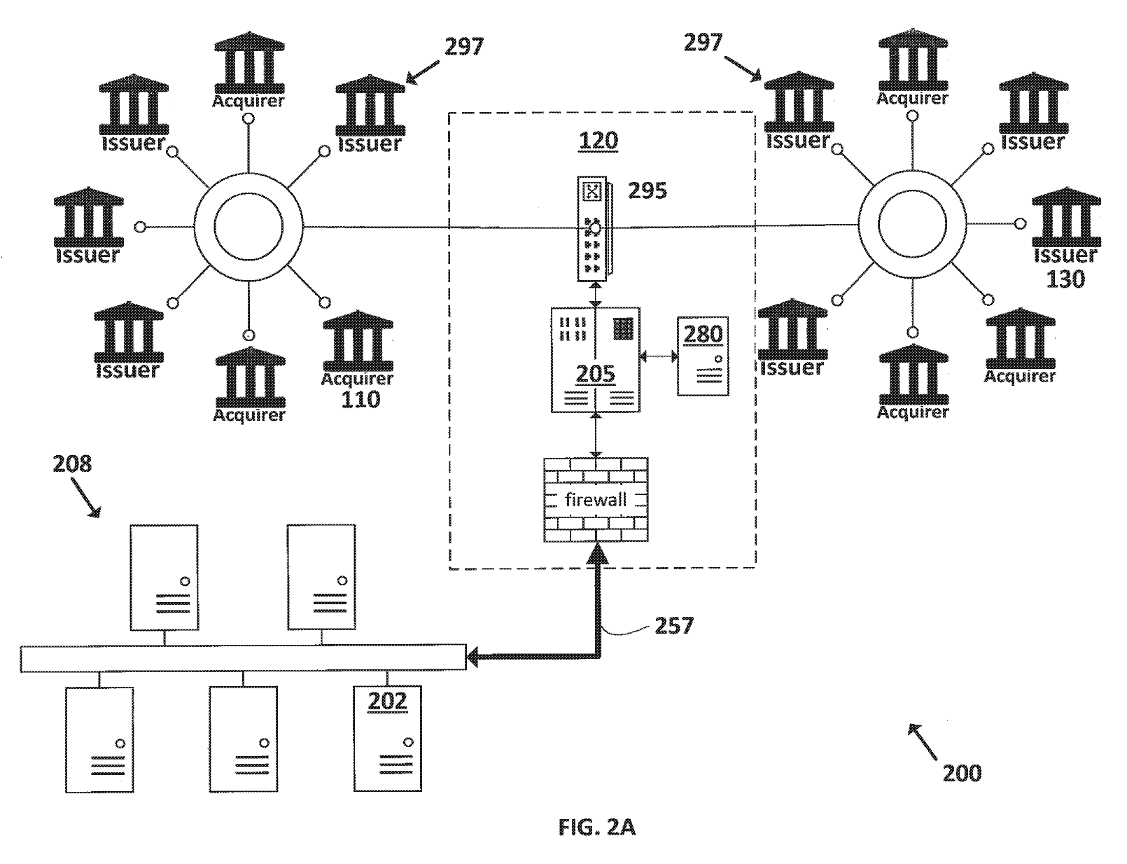

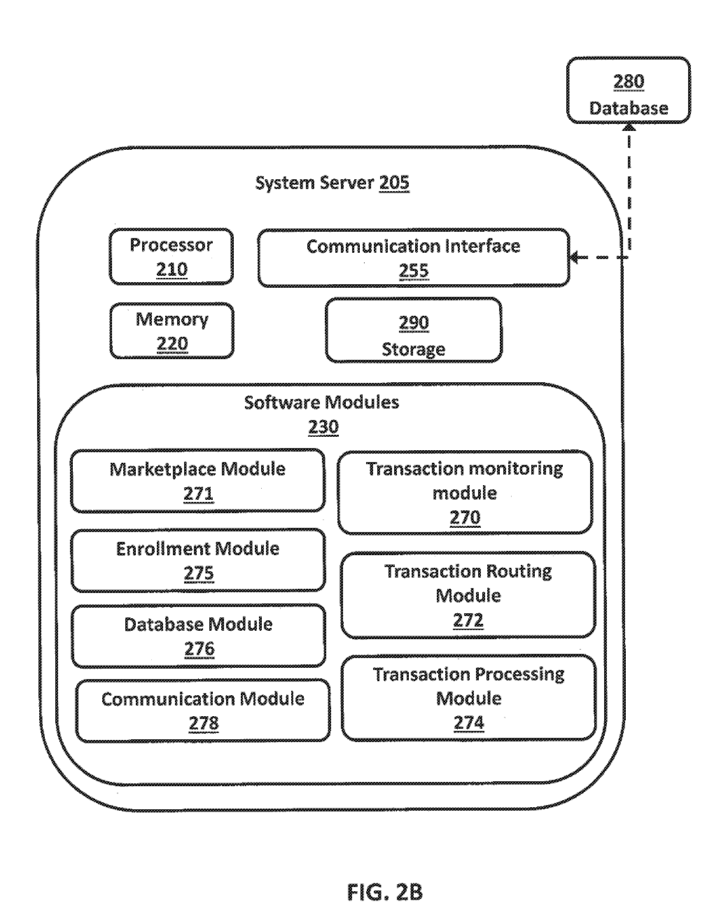

It should be understood that authorization, clearing and settlement of payment transactions are non-limiting examples of transaction processing operations conducted by and using the payment device network system 120 and that can be enhanced through the integration of VAS Apps into the infrastructure of the payment device network system and into the existing transaction processing workflows using the exemplary payment network platform further described herein. It should be further understood that, in addition or alternatively to enhancing the actual processing of transactions as they are “in flight” through the payment device network system 120, integration of VAS Apps 208 (shown in FIG. 2A) using the exemplary payment network platform can also enable such VAS Apps to leverage the transaction information to separately provide additional services to network participants offline (e.g., without necessarily altering or enhancing the processing of “in-flight” transactions).

FIG. 2A is a block diagram illustrating an exemplary configuration of a payment network platform 200 in accordance with one or more of the disclosed embodiments. As shown, the payment network platform 200 includes a system server 205. In the example embodiment, the system server 205 is a computing system that is implemented within the infrastructure of the payment device network system 120 which, for example and without limitation, can be part of the exemplary multi-party transaction system 100 of FIG. 1. The system server is thus configured to have direct access to the transaction data flowing through the payment device network system 120 between the network participant systems 297 communicatively coupled thereto.

The system server 205 also provides and manages the communication interface between the various VAS Apps 208 and the payment device network system 120 via a communication connection 257. In particular, the system server is configured to selectively provide one or more of the VAS Apps with access to information about qualifying transactions that are being processed by and through the payment device network system. As noted, the purpose of the provided access can be for the one or more VAS Apps to perform supplemental processing of the qualifying transactions, as authorized by one or more of the transacting network participants. In addition, the system server can be further configured to utilize the existing infrastructure and transaction processing workflows of the payment device network system to communicate the results of any supplemental processing by one or more of the VAS Apps 208 to one or more of the network participant systems 297 that are connected to the payment device network system 120.

The system server 205 can be a stand-alone computing system in communication with one or more of the computing systems comprising the payment device network system 120. For example, FIG. 2A shows the system server in communication with a switch network 295, which can be used to route transaction messages between the network participants 297. However, features and functionality of the system server 205 further described herein can be implemented using one or more of the existing computing devices that comprise the payment device network system without departing from the scope of the disclosed embodiments.

FIG. 2B is a more detailed block diagram illustrating an exemplary configuration of the system server 205 in accordance with one or more of the disclosed embodiments and is further described herein with continued reference to the payment network platform 200 of FIG. 2A. System server 205 can include a processor 210, which is operatively connected to various hardware and software components that serve to enable operation of the systems and methods described herein. The processor 210 can be a number of processors, a multi-processor core, or some other type of processor, depending on the particular implementation, and serves to execute instructions to perform various functional operations, as is described in greater detail below.

A communication interface 255 is also operatively connected to the processor 210. The communication interface can be any interface that enables communication between the system server 205 and external computing devices, machines and/or functional modules. In certain implementations, the communication interface includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting the system server to other computing devices and/or communication networks, such as private networks and the Internet. Such connections can include a wired connection or a wireless connection (e.g., using the IEEE 802.11 standard known in the relevant art) though it should be understood that communication interface can be practically any interface that enables communication to/from the processor directly and over networks, such as a local area network (LAN) or a wide area network (WAN), dial-in-connections, cable modems, and special high-speed Integrated Services Digital Network (ISDN) lines.

In some implementations, a computer readable, non-transitory, memory 220 and/or a storage medium 290 are accessible by the processor 210, thereby enabling the processor 210 to receive and execute instructions stored on the memory 220 and/or on the storage 290 and otherwise access data stored therein. The memory 220 can be, for example, a random access memory (RAM) or any other suitable volatile or non-volatile computer readable storage medium. In addition, the memory 220 can be fixed or removable. The storage 290 can take various forms, depending on the particular implementation. For example, the storage 290 can contain one or more components or devices such as a hard drive, a flash memory, a rewritable optical disk, a rewritable magnetic tape, or some combination of the above. The storage 290 also can be fixed or removable. Although the storage 290 is depicted as being configured locally on the system server 205, in some implementations the storage 290 ore one or more of the data elements stored therein can be stored on a computer readable storage medium that is located remotely and accessible to the system server 205.

Also accessible to the processor in accordance with certain embodiments is a database 280. Database 280 contains and/or maintains various data items and elements that are generated or utilized throughout the various operations performed by the payment network platform 200. It should be noted that although the database 280 is depicted as being separate from the storage 290, in some implementations the database can be stored locally in the storage 290 or in another storage medium that is accessible to the processor 210.

For example, in some embodiments, the database 280 can be used by one or more of the computing devices of the payment network platform 200 to store transaction data concerning transactions processed within the payment network platform 200 including data relating to merchants, account holders or consumers, issuers and acquirers and the like. By way of further example, the database 280 can also be used store transaction data relating to the authorization, settlement and clearing of such transactions by and through the payment device network system 120.

As noted, to facilitate the authorization, clearing, and settlement of transactions, among other transaction processing operations, the payment device network system 120 receives transaction messages concerning transactions between one or more of the network participants 297, gathers transaction data therefrom and processes and/or routes transaction messages in accordance with transaction processing work-flows that are established for respective types of transactions. A transaction messages is referred to as being “in flight” through the payment device network system in that it is typically received from one of the network participants 297, and routed by the payment device network system 120 to an intended recipient (e.g., another network participant) for further processing.

As would be understood, the content and the form of transaction messages can be defined by one or more standards or protocols promulgated by the payment device network system 120, an International Organization for Standardization (ISO), standardized communication protocols and the like. For example and without limitation, the information included in an exemplary payment authorization request transaction message, and which can be provided in one or more fields of the transaction message, can include, Acquirer IDs (identification data), Issuer IDs (identification data), Merchant IDs (identification data), Merchant Name, Transaction Amount, Transaction Details (e.g., Stock Keeping Unit (SKU) description identifying items in the transaction etc.), Account Holder Name, Payment Account Number, and the like. Transaction messages can also include one or more proprietary or discretionary data fields. As noted above and further described herein, the payment device network system 120 can share the data elements of a transaction message, where appropriate, with one or more of the network participants 297 that are parties to the transaction so as to facilitate the authorization, clearing and settlement between the transacting network participants. In addition, the acquired transaction data can also be stored in the database 280 for recordation purposes and further analysis and processing by one or more of the computing devices comprising the payment network platform 200.

FIG. 2B also depicts one or more software modules 230, which can be encoded in the storage 290 and/or in the memory 220. The software modules 230 can comprise one or more software programs or applications having computer program code or a set of instructions that, when executed by the processor 210, configure the processor to perform various functional operations of the payment network platform 200. For example and without limitation, included among the software modules 230 is a transaction monitoring module 270, a marketplace module 271, a transaction routing module 272, a transaction processing module 274, an enrollment module 275, a database module 276, and a communication module 278.

The communication module 278 serves to configure the system server 205 to communicate, either directly or indirectly, with various computing devices that comprise the payment network platform 200. In particular, the communication module 278 can configure the system server to implement an application programming interface (API) that enables the VAS Apps 208 (or network participants 297) to connect to the payment network platform 200, transmit or receive information via the payment network platform, and provide (or receive) services via the payment network platform. The system server 205 can also be configured to forward transaction messages to one or more of the network participants 297 using the existing infrastructure and protocols of the payment device network system 120 such as switch network 295, communication interfaces, and the like.

The enrollment module 275 serves to configure the system server 205 to enroll the VAS Apps 208 into the payment network platform 200. In connection with enrollment, the system server can implement various processes for certifying and enforcing compliance with appropriate security and technical requirements. The certification process can also include the automated and/or manual vetting and security due diligence required for connecting a given VAS App with the payment device network system 120. Security due diligence might or might not include verifying Payment Card Industry (PCI) compliance depending on whether a VAS App only accesses anonymized data and whether any transaction account or payment device credentials are exposed. In addition, the system server can also be configured to provide third-party service providers with the facility to register account receivables information with the system server and authorize the system server to bill and collect on VAS App services provided through the payment network platform 200. The enrollment module can also configure the system server to similarly enroll network participants as well.

The marketplace module 271 serves to configure the system server 205 to provide a computer-accessible portal or “store front” through which network participants can review the services offered by the VAS Apps 208 and subscribe to or enroll in such services. As used herein, the term “subscriber” is intended to refer to a network participant that has subscribed to services provided by one or more VAS Apps. In this regard, the store front can be the likes of an application store whereby terms and conditions associated with respective VAS Apps can be reviewed and agreed upon by the subscriber and whereby the subscriber authorizes a VAS App to use certain transaction data elements when providing services to the subscriber.

In some exemplary embodiments, the marketplace component implemented by the system server 205 can also serve to facilitate the distribution of information, instructions and/or software by a VAS App to a subscriber and that can be implemented by the subscriber to utilize the services provided by the VAS App. For instance, the VAS App 202 can provide the issuer 130 with software in the form of a plug-in or stand-alone fraud detection application that can be used to enhance the issuer's existing transaction authorization system according to the fraud level results generated by the VAS App 202 and provided to the issuer 130 via the payment network platform 200, as further described herein.

In connection with enrollment of the VAS Apps 208 and any network participants 297, the database module 276 can configure the system server 205 to generate and maintain profiles for respective VAS Apps and respective subscribers in the database 280. In some embodiments, the database module can also configure the system server to maintain historical records detailing the various transactions that are processed by the VAS Apps on behalf of one or more respective subscribers and associated results.

More specifically, during enrollment, the processor 210 of system server 205, which is configured by executing one or more software modules 230 including, the marketplace module 271, enrollment module 275, database module 276, and communication module 278, can be configured to collect and store information about each subscriber and their respective subscriptions to one or more of the VAS Apps 208. In some embodiments, the subscriber information can include unique identifiers such as account names or numbers that can be used to determine whether a given subscriber is a party to a transaction in flight through the payment device network system 120.

Enrollment of a subscriber/network participant can also include prompting each subscriber to agree to or otherwise define and/or modify subscription settings (also referred to as usage criteria), which can be recorded in the database 280, for instance, in a respective subscriber profile or a respective VAS App profile. In general, usage criteria are specific rules that define how and under what circumstances a respective VAS App processes transactions on behalf of a respective subscriber. According to one aspect, the criteria can specify the data-elements of a transaction message that should be shared with a given VAS App. For example and without limitation, the usage criteria can specify one or more of: a set of data elements that are necessary for a given VAS App to perform its respective function; data elements that a given subscriber does not want the given VAS App to access; data elements that the given VAS App does not want to receive, or any combination of the foregoing.

The usage criteria can also include rules and conditions governing what types of transactions (i.e., “qualifying transactions”) are to be processed by a given VAS App on behalf of a given subscriber. For example, the usage criteria can specify that only payment authorization messages for transactions involving the given subscriber and having a value of over $100 dollars qualify for supplemental processing using the given VAS App. The settings can further specify that only a particular set of data elements, say, time, date, location, merchant name, and acquirer entity ID, should be made available to the given VAS App for transactions valued at over $100 dollars and that additional data elements (e.g., an account-holder name and address) can be made available to the given VAS App for transactions valued at over $1000.

In some embodiments, the usage criteria can also specify specific processing work flows that are implemented by the system server 205 for qualifying transactions having prescribed characteristics. For instance, the usage criteria can specify that certain types of transactions are “high-priority” transactions that require supplemental processing to be completed by a given VAS App prior to being further processed by the payment device network system 120 in accordance with the typical transaction processing workflow. By way of further example, the usage criteria can specify that low priority transactions can be routed for further processing if supplemental processing has not been completed by a given VAS App within an allotted amount of time. The term “typical transaction processing workflow” is intended to refer to one or more established transaction processing workflows that the payment device network system implements when processing or routing transaction messages between one or more of the network participants 297, as would be understood by those in the art.

The transaction monitoring module 270 configures the system server 205 to monitor transaction messages that are in-flight through the payment device network system 120, and identify any payment transactions that are qualified for supplemental processing by one or more of the VAS Apps 208 (i.e., are a “qualifying transaction”).

For example and without limitation, upon receipt of a transaction message representing a payment transaction authorization request and including data elements identifying an issuer and an acquirer, the processor 210 can be configured to analyze the transaction message and cross-reference the identified acquirer or issuer with a look-up table of subscribers. Additionally, in response to identification of a particular subscriber, say, issuer 130, as having subscribed to a given VAS Apps, say, VAS App 202, the configured processor can determine, according to the usage criteria stored in issuer 130's subscriber profile, whether the particular transaction meets the criteria that qualify the transaction for supplemental processing by the given VAS App.

The transaction routing module 272 serves to configure the system server 205 to, in the case where a transaction is a non-qualifying transaction, route the non-qualifying transaction for further processing in accordance with the established transaction processing workflows of the payment device network system 120. The transaction routing module also serves to configure the system server to, in response to determining that a particular transaction is qualified for supplemental processing by a VAS App, provide information concerning the qualifying transaction to the VAS App, thereby facilitating the supplemental processing of the transaction by the VAS Apps.

The system server can provide such information in accordance with the stored usage criteria established for the VAS App and which, as noted, can specify data elements required by the VAS App, data elements that the VAS App is not authorized to access, or even data elements that the VAS App does not want to receive. Accordingly, in some implementations the information shared with the VAS App can include a subset of the data elements included in the transaction message. In addition or alternatively, the system server 205 can provide non-essential information included in the transaction message or even the entire transaction message. In some embodiments, the system server can also provide additional information.

The system server 205 can provide the VAS App with access to the information in a variety of ways. In some embodiments, the system server can be configured to forward the transaction message to the VAS App 202 via the communication connection 257. For instance, the switch network 295, which is used by the payment device network system when routing transaction messages between network participants, can be used to route the transaction message to the appropriate VAS App either directly or via the system server 205. In addition or alternatively, the system server can selectively permit the VAS App to retrieve the data elements of the transaction message from a storage medium. For instance, the system server can be configured to notify the VAS App of a qualifying transaction, thereby prompting the VAS App to retrieve the information stored in the database 280 by way of an API call over the communication connection 257. In addition or alternatively, the system server can be configured to selectively allow the VAS App to intercept the qualifying transaction message as it is in flight within the payment network.

As previously noted, any of the various features and functions of the system server 205 can be implemented, either wholly or partially, by one or more of the existing computing devices that comprise the payment device network system 120. For instance, in an exemplary implementation further described herein the switch network 295 can be configured to perform the function of identifying and routing qualifying transactions based on routing tables. More specifically, according to the current payment device network processing model, the switch network 295 can be configured to reroute transactions based on routing table entries. The primary key for these routing tables are based out of ISO defined Bank Identification Numbers (BIN), which are typically the first six (6) digits of the card account number or the first eleven (11) digits of the same account numbers called account ranges. In accordance with one or more of the disclosed embodiments, a routing table can be defined to also include an attribute that marks account ranges that are associated with network participants that have subscribed to services provided by one or more of the VAS Apps 208 (i.e., subscribers). Accordingly, if an inbound transaction message includes a BIN falling within an account range marked in the routing table as being associated with a subscriber, the transaction can be routed by the switch network 295 to the system server 205 according to the logic further described herein. In other words, transactions determined to be associated with subscribers can be rerouted momentarily by the switch network 295 to the system server 205 for further processing by the system server and possibly one or more of the VAS Apps, before proceeding back to usual network traffic. Accordingly, it can be appreciated that the existing technology can be used to facilitate supplemental processing of a transaction and preferably occurs within a short window of time before the transaction is returned to the typical processing protocol. It should be understood that, while BINs/Account Ranges are used in this exemplary embodiment, routing tables based on bank account routing number can similarly be utilized to provide the same routing methodology in an ACH routing environment.

The transaction processing module 274, in general, serves to configure the system server 205 to receive transaction information concerning one or more transactions and analyze and process the information as further described herein. For instance, the transaction processing module can configure the system server to enhance a received transaction message with the result of supplemental processing of the transaction by a VAS App prior to forwarding the transaction message back into the typical transaction processing workflow.

More specifically, in accordance with one or more of the disclosed embodiments, the processor 210 of server 205, which is configured by executing one or more software modules 230 including, but not limited to, the communication module 278 and the transaction processing module 274, can receive the result of the supplemental processing of a qualifying transaction from one or more of the VAS Apps 208 and enrich the corresponding transaction request message according to the result. For instance, in a practical example of processing a payment authorization request wherein the VAS App 202 is used to detect fraud on behalf of the issuer 130, the VAS App 202 can transmit a supplemental processing result comprising a fraud risk level for the transaction to the system server 205 over the communication connection 257. In response, the system server can update one or more fields of the original transaction message to include the fraud risk level and thereby create a transaction message that has been enriched according to the result.

As would be understood by those in the art, the system server 205 or the payment device network system 120, more generally, can be configured to perform any number of additional processing, transformation or enrichment steps before forwarding a transaction message to the intended recipient for further processing. Such processing can be performed in accordance with the payment device network system 120's typical transaction processing protocols and can be performed either prior to or after supplemental processing of a transaction using one or more of the VAS Apps 208. Accordingly, it should be appreciated that reference to an “enriched transaction message” is not limited to a modified version of a transaction message originally received by the payment device network system 120 and can include derivatives thereof as well as an entirely new transaction message generated based on or in response to the received transaction message.

In addition, in cases where supplemental processing has been performed using a VAS App, the transaction routing module 272 can also configure the system server 205 to route the transaction message for further processing in accordance with the established transaction processing workflow of a typical payment transaction passing through the payment device network system 120. More specifically, in one or more exemplary embodiments, the processor 210 of the system server 205, which is configured by executing one or more software modules 230 including, but not limited to, the transaction routing module 272, can forward an enriched transaction message to the switch network 295 such that it can be routed to one or more intended recipients (e.g., one or more of the network participants 297) in accordance with the typical transaction processing workflow. For instance, in the practical example of processing a payment authorization request transaction message, wherein the transaction message is received from the acquirer 110 and processed by the VAS App 202 on behalf of the issuer 130, the typical transaction processing workflow can provide that the switch network 295 forwards the transaction message to the issuer 130. Accordingly, in response to receipt of the enriched transaction message from the switch network 295, the issuer 130 can then process the enriched transaction message and decline or accept the transaction authorization request.

In addition or alternatively, the supplemental processing result can transmitted to the subscriber of the supplemental processing separately from the corresponding transaction message. In yet a further example, the supplemental result can be stored in a record of the transaction in the database 280. Accordingly, the result can be accessed by the subscriber, say, issuer 130, in connection with subsequent processing of the transaction or offline (e.g., separate from the processing of the transaction message). Access to the transaction record can be similarly provided to the VAS App 202, the payment device network system 120 or other authorized parties to the transaction. It should also be understood that, in some implementations, one or more of the foregoing operations for augmenting the transaction record and/or transmitting the supplemental processing result that are described as being performed by the system server 205 can similarly be performed by a VAS App or other devices within the payment device network system 120.

Although software modules 230 are depicted as being stored locally at the system server 205, the disclosed embodiments are not so limited, as one or more of the modules can be stored on one or more remote storage mediums that are accessible to the processor 210. The program code can execute entirely on the system server 205 as a stand-alone software package, partly on the system server and partly on one or more other computing devices, or entirely on such other computing devices. In the latter scenario, the other computing devices can be connected to the system server through any type of wired or wireless network (not shown). In addition, in some illustrative embodiments, one or more of the software modules 230 can be downloaded by the system server 205 to the storage 290 from another device or remote system via the communication interface 255 for use within the payment network platform 200.

The operation of the exemplary payment network platform 200 and the various elements and components described above are further appreciated with reference to the methods for selectively facilitating supplemental processing of qualifying payment transactions on a payment network by VAS Apps described below and with continued reference to FIGS. 2A-2B.

It should be appreciated that several of the logical operations described herein are implemented (1) as a sequence of computer implemented acts or program modules running on the various devices of the payment network platform 200 and/or (2) as interconnected machine logic circuits or circuit modules within the system. The actual implementation is a matter of design choice dependent on the requirements of the device (e.g., size, energy, consumption, performance, etc.). Accordingly, the logical operations described herein are referred to variously as operations, steps, structural devices, acts, or modules. As referenced above, the various operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

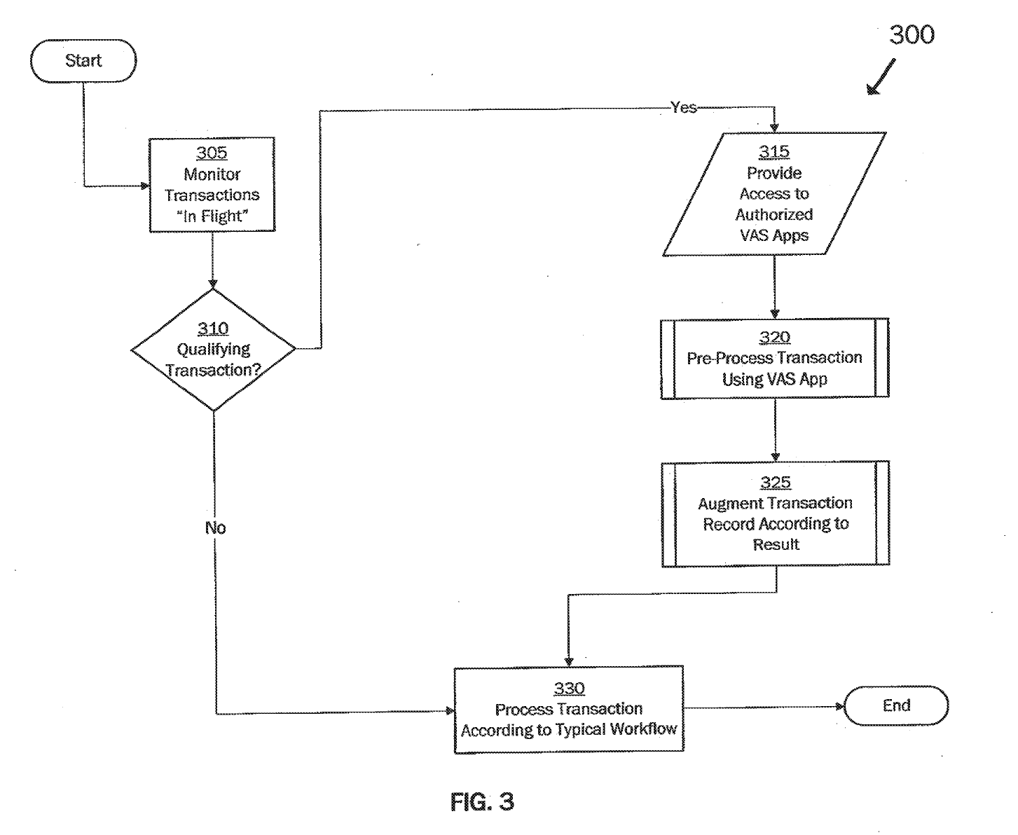

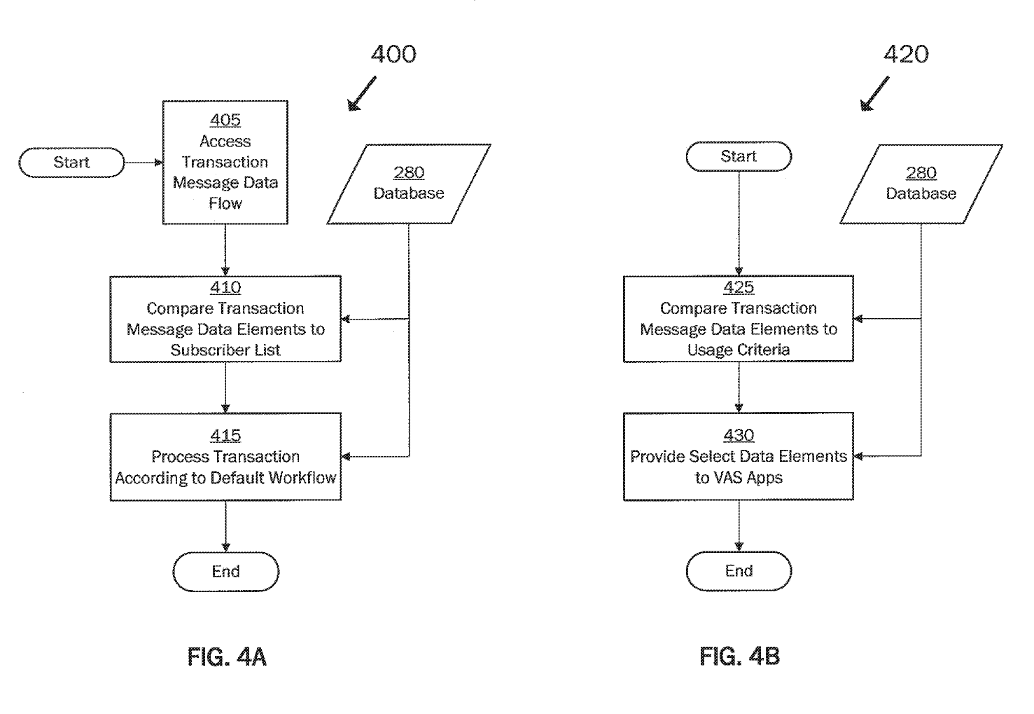

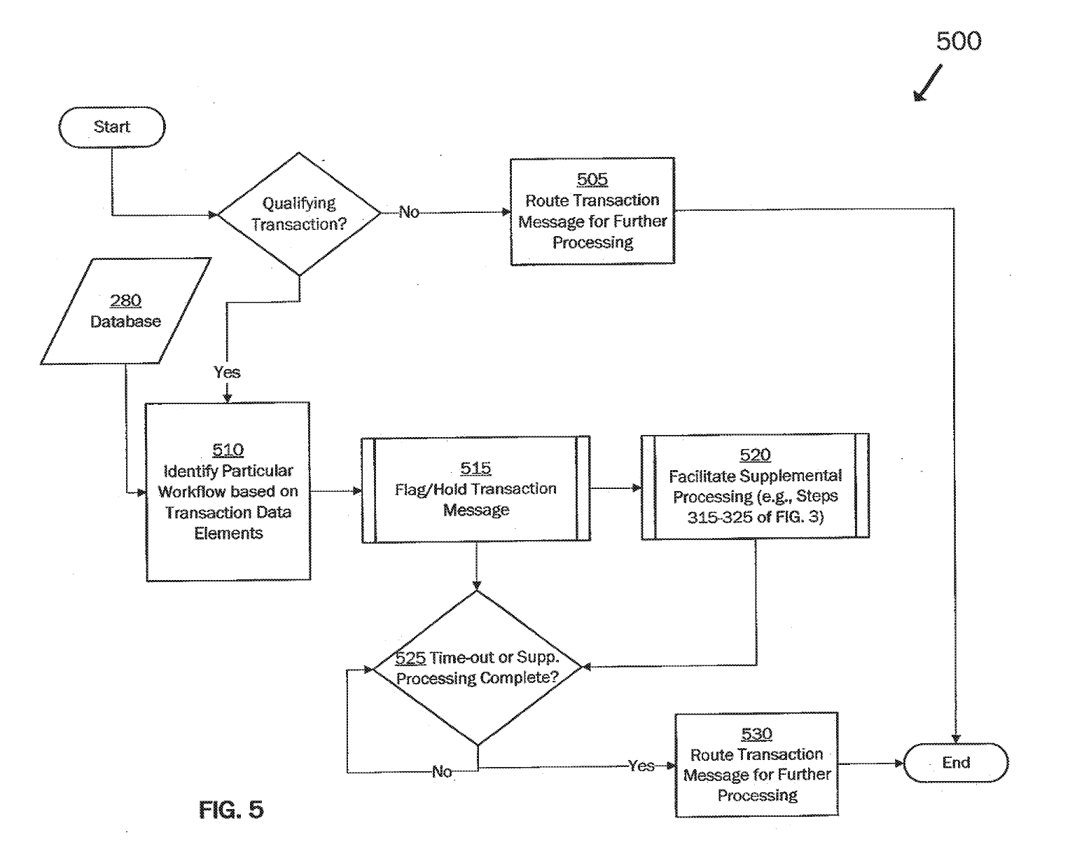

FIG. 3 is a flow diagram illustrating a method 300 for selectively facilitating supplemental processing of qualifying payment transactions on a payment device network system by one or more of VAS Apps in accordance with at least one embodiment disclosed herein. As a non-limiting practical example, routine 300 is described in the context of processing a payment authorization request transaction message for a transaction involving the acquirer 110 and the issuer 130. However, it should be understood that the disclosed embodiments can similarly be applied to other types of transaction processing operations, such as transaction clearing and settlement operations coordinated using the payment device network system 120. In addition, the practical example described herein concerns processing a payment authorization request transaction message received from the acquirer 110 and destined to be forwarded to the issuer 130 for authorization. However, it should also be understood that the disclosed embodiments can similarly be used to process transaction messages received at the payment device network system 120 at other stages or “legs” of a given transaction processing workflow. For instance, supplemental processing of transactions using one or more of the VAS Apps 208 can be performed on a payment authorization response transaction message received from the issuer 130 and intended to be forwarded by the payment device network system 120 back to the acquirer 110.

The routine 300 begins at step 305, where the system server 205 monitors transactions being routed through the payment device network system 120. In connection with monitoring the payment transactions, at step 310, the system server 205 identifies transactions that qualify for supplemental processing by one or more VAS Apps (“qualifying transactions’).

An exemplary subroutine 400 for monitoring transaction messages and identifying qualifying transactions is illustrated in FIG. 4A. The subroutine 400 begins at step 405 in which the processor 210 of system server 205, which is configured by executing one or more of the software modules 230 including, but not limited to, the transaction monitoring module 270, accesses a real time or near-real time data feed of in-bound transaction messages received by the payment device network system 120 from one or more of the network participants 297. In addition, the configured processor analyzes data elements of each in-bound transaction message in view of the information stored in the database 280 in order to determine whether a given transaction involves any subscribers to one or more of the VAS Apps 208. For instance, at step 410, the configured processor can cross-reference the acquirer or issuer identified in an in-bound transaction message with a look-up table of subscribers to one or more of the VAS Apps 208. Additionally, at step 415, in response to identification of a particular subscriber, say, issuer 130 as having subscribed to VAS App 202, the configured server can further verify, according to the stored usage criteria for issuer's 130 subscription to VAS App 202, whether the particular transaction meets the criteria that qualify it for supplemental processing by the VAS App 202.

Returning now to FIG. 3, in response to identifying a qualifying transaction that is eligible for supplemental processing by one or more VAS Apps, at step 315, the system server can facilitate supplemental processing of the transaction by providing the one or more VAS Apps with access to information concerning the transaction and thereby enabling the VAS App to process the transaction.

An exemplary subroutine for providing the VAS App 202 with access to information concerning a qualifying transaction is illustrated in FIG. 4B and briefly described herein. The subroutine 420 begins at step 425 in which the processor 210 of system server 205, which is configured by executing one or more of the software modules 230 including, but not limited to, the transaction routing module 272, analyzes the data elements of the transaction message according to the usage criteria established by the issuer 130 and/or the VAS App 202 and stored in the database 280. Accordingly, the configured processor can determine which of the data elements it is authorized to provide the VAS App 202 and, at step 430, can provide the select set of data elements to the VAS App for supplemental processing of the transaction.

Returning now to FIG. 3, at step 320, the one or more authorized VAS Apps processes the qualifying transaction. The VAS Apps 208 can perform any number of different processing functions using the data elements made available by the system server 205. As can be appreciated, the types of services that the VAS Apps can provide to subscribers by leveraging the transactions flowing through the payment device network system 120 is virtually unlimited. For instance, in the practical example of processing a payment authorization request transaction message, the VAS App 202 can be configured to analyze the data elements to detect fraudulent transactions on behalf of the issuer 30. Such supplemental processing occurs in certain embodiments prior to the transaction message being routed through the payment device network system 120 to the issuer 130 for approval in accordance with the typical payment transaction authorization workflow. Accordingly, the supplemental processing performed by a given VAS App can be referred to as “pre-processing” in that it occurs before a subsequent processing step in the typical transaction processing work-flow. However it should be understood that supplemental processing can be performed subsequent to or dynamically alongside other transaction processing steps.

Then at step 325, the information generated through supplemental processing of the transaction by the one or more VAS Apps is used to enhance a record of the transaction. As noted, in accordance with one or more of the disclosed embodiments, the processor 210 of system server 205, which is configured by executing one or more software modules 230 including, but not limited to, the communication module 278 and the transaction processing module 274, can receive the result of the supplemental processing from one or more of the VAS Apps 208 and enrich the corresponding transaction message according to the result. For instance, in the payment authorization request transaction processing example, the VAS App 202 can transmit a result comprising a fraud risk level for the transaction to the system server 205 over the communication connection 257. In response, the system server can update one or more fields of the in-bound transaction message to include the fraud risk result and thereby create an enriched transaction message that can be forwarded to the issuer 130. In addition or alternatively, the supplemental processing result can transmitted to the issuer 130 separately from the transaction message and/or can be recorded in a transaction record that is accessible to the issuer 130.

Then at step 330, the transaction message is further processed in accordance with the default transaction processing workflow of the payment network system 120. More specifically, in one or more embodiments, the processor 210 of the system server 205, which is configured by executing one or more software modules 230 including, but not limited to, the transaction routing module 272 and the communication module 278, can forward a transaction message that has been enriched at step 325 to one or more intended recipients via the payment device network system 120. For instance, in the payment authorization request transaction processing example, the typical transaction processing workflow can provide that the network switch 295 routes the transaction message received from the acquirer 110 to the issuer 130 identified in the transaction message. Accordingly, the system server 205 can be configured to provide the enriched transaction message to the network switch 295 such that it is forwarded to the issuer 130.

As should be understood, in some implementations, subsequent processing of a transaction by a network participant can be informed by the supplemental processing result included in the enriched transaction message. For example, in the practical payment authorization request transaction processing example wherein the enhanced transaction message includes the fraud risk determined by VAS App 202, the issuer 130 can decline or accept the authorization request in view of the included fraud risk level. In some implementations, the subsequent processing is not necessarily informed by the supplemental process result.

It should be understood that the exemplary application of the disclosed systems and methods to process payment authorization request transaction message using VAS App 202, which determines a fraud risk level through supplemental processing, is provided as a non-limiting example. VAS Apps can be configured to provide a variety of services at any leg of a transaction authorization, clearing, settlement transaction and the like. For example and without limitation, a given VAS App can be subscribed to by the acquirer 110 to provide inventory management services for a merchant that is party to a transaction. In particular, a transaction message on the return leg from the issuer 130 to the acquirer 110, wherein the transaction has already been approved by the issuer, can be routed for processing by the inventory management VAS App so as to mark any transacted-for items as being “sold” in the selling merchant's inventory management system. By way of further example, the VAS App can be configured to manage accounts receivables for a company and provide notification messages to the company in a similar fashion to the foregoing inventory management example.

As yet another non-limiting example, a given VAS App can be configured to implement a loyalty rewards system for an issuer 130 and can perform supplemental processing of a qualifying transaction so as to provide the issuer with a computation of loyalty rewards points (e.g., a credit in the form of a dollar amount) that can be redeemed during the qualifying transaction. By way of further example, the VAS App can be configured to provide accounting services that provide a notification to a merchant's (or a consumer's) accounting system of a successfully paid bill.

As noted, the exemplary systems and methods disclosed herein enable VAS Apps to perform supplemental processing on select transactions performed within a multi-party payment transaction system (e.g., system 100 as shown in FIG. 1) and enhance the transaction processing operations while the transaction messages are “in flight” through the payment device network system 120. In the interests of efficiency and scalability of the platform 200, it is further preferable that supplemental processing of a transaction is performed without disturbing the existing infrastructure between the payment device network system 120 and the network participants 297 connected thereto and without alteration of the established transaction processing workflows, as perceived by other parties to the transaction. It is further preferable that the disclosed systems and methods can achieve the benefits of supplemental processing with only limited modification of the payment device network system's internal protocols for handling transaction messages in-flight therethrough. Thus, in accordance with one or more of the disclosed embodiments, the system server 205 can be configured to implement routines for handling transaction messages consistent with the established standards, workflows and rules that can be required of the various parties to a multi-party payment transaction system like system 100 of FIG. 1.

FIG. 5 is a flow diagram illustrating an exemplary subroutine 500 for handling transaction messages processed in accordance with one or more of steps of routine 300 and in compliance with established standards, workflows and rules, as can be required in a multi-party payment transaction system (e.g., system 100 as shown in FIG. 1). For instance, in one or more embodiments, steps of the subroutine 500 can be implemented by the system server 205 in connection with one or more of steps 305, 310 and 330 of routine 300.

In particular, in the case where it is determined that a particular transaction is a non-qualifying transaction, at step 505, the transaction routing module 272 serves to configure the processor 210 of the system server 205 to enable further processing of the non-qualifying transaction by the payment device network system 120 in accordance with a typical transaction processing workflow. In some implementations, the system server 205 can be configured to take no affirmative action with respect to the non-qualifying transaction at step 505, thereby allowing the payment network device system 120 to process the transaction message without input or action by the system server. In addition or alternatively, the system server 205 can be configured to route or otherwise flag the transaction message for further processing by the payment device network system 120, for instance, by transmitting the transaction message to the switch network 295 for forwarding to one or more of the network participants 297.

In the case where it is determined that a particular transaction is a qualifying transaction, the transaction routing module 272 serves to configure the processor 210 of the system server 205 to enable supplemental processing of the qualifying transaction.

In particular, at step 510, the configured system server 205 can compare data elements of the transaction message to the usage criteria and information stored in the database 280 in order to identify and implement a specific transaction processing workflow for the qualifying transaction. As noted, in some embodiments, the particular transaction processing workflow can be defined by subscription settings/usage criteria associated with a given subscriber's subscription to a given VAS App. In addition, the workflow can be defined according to standards required for processing transactions in a multi-party payment transaction system. For example and without limitation, the prescribed transaction processing work flow can require a prescribed time-out period within which the supplemental processing steps (e.g., one or more of steps 315-325 of routine 300) should be completed before the transaction message is automatically processed by the payment device network system 120 in accordance with the typical payment processing workflow.

Accordingly, at step 515, the configured system server 205 can operatively hold the transaction message pending supplemental processing of the qualifying transaction using one or more of the VAS Apps 297 (e.g., by performing one or more of steps 315-325 of routine 300), which occurs at step 520. Operatively holding the transaction message can be achieved by, for example and without limitation, annotating/flagging the transaction message or an associated transaction record maintained internally by the payment device network system 120 and thereby preventing further processing of the transaction message, at least temporarily. Accordingly, at step 525 the system server 205 can determine whether the supplemental processing is complete or a time-out period has elapsed. Based on the determination, at step 530, the system server 205 can route the transaction message, either in its unaltered or enhanced form, for further processing via the payment device network system 120, as described above.

In view of the foregoing, it can be appreciated that the integration of the VAS Apps into the payment device network system in accordance with the systems and methods described herein provide the technical advantage of enabling VAS Apps to perform supplemental processing on select transactions through direct communication with the system server 205 existing within the payment device network system 120 (e.g., via an independent side-channel communication connection) and augment the transaction processing operations while the transactions are “in flight” through the payment device network system. The VAS App integration and the supplemental processing can also be performed without alteration of the existing payment device network infrastructure that facilitates communication between the payment device network system and the network participants. The disclosed systems and methods can also achieve these benefits with only limited modification of the payment device network system's internal protocols for handling transaction messages in-flight therethrough. Moreover, the systems and methods described herein further provide the advantage of transforming, updating, and/or enhancing transaction messages based on the supplemental processing by a VAS App without disturbing the overall transaction processing workflow as perceived by other parties to the transaction. Moreover, the systems and methods described herein further provide the advantage of transforming, updating, and/or enhancing transaction messages based on supplemental processing by one or more VAS Apps in a way that can be utilized by a subscribing network participant and without altering the transaction message in a way that would interfere with subsequent processing of the transaction by any non-subscribing network participants.

Furthermore, selectively providing the VAS Apps with access to the information allows the payment device network system 120 to enforce the necessary security and transaction processing protocols. Similarly, by reconciling the result with the original transaction request using the system server 205 prior to further processing of the transaction according to default transaction processing workflows enables the VAS Apps to provide services and augment the transaction processing without compromising the security and reliability of the underlying transaction message.

At this juncture, it should be noted that although much of the foregoing description has been directed to systems and methods for providing a payment network platform for processing payment transactions conducted over a payment device network system and selectively facilitating supplemental processing of qualifying payment transactions by third-party value adding service applications, the systems and methods disclosed herein can be similarly deployed and/or implemented in scenarios, situations, and settings far beyond the referenced scenarios.

It is to be understood that like numerals in the drawings represent like elements through the several figures, and that not all components and/or steps described and illustrated with reference to the figures are required for all embodiments or arrangements. Thus, illustrative embodiments and arrangements of the present systems and methods provide a computer implemented method, computer system, and computer program product for facilitating the automatic provisioning of an electronic record to a user conducting a transaction at a transaction terminal. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims. cm What is claimed is:

1. A method for processing transactions conducted over a payment device network system and selectively facilitating supplemental processing of qualifying transactions by third-party value adding service applications, comprising:
providing, with a server computing device within the payment network, a communication connection between the system server and respective third-party value adding service applications (VAS apps) for transmitting transaction messages between the payment device network system and the VAS apps, and a communication connection between the system server and a plurality of network participant systems for transmitting transaction messages between the payment device network system and the network participants;
storing, in a database that is accessible to the system server, predefined usage criteria specifying conditions for performing supplemental processing of transactions on behalf of respective network participants using respective VAS apps;
receiving a transaction request at the system server concerning a transaction associated with at least one network participant;
determining, with the system server according to the transaction request and the predefined usage criteria, whether the transaction is qualified for supplemental processing by at least one of the VAS apps;
in response to determining that the transaction is a qualified for supplemental processing by the at least one VAS app,
transmitting, one or more data elements of the transaction request to the at least one VAS app for supplemental processing of the qualifying transaction, and
receiving, from the at least one VAS app, a result of the supplemental processing by the at least one VAS app; and
forwarding, by the system server, the transaction request for further processing by the payment device network system in accordance with a default payment processing workflow, wherein the forwarded transaction request comprises the received transaction request and any result of pre-processing the transaction request by the at least one VAS app.

2. The method of claim 1, further comprising:
enriching, by the system server, the transaction request associated with the qualifying transaction according to the result received from the at least one VAS app; and
wherein the enriched transaction request is forwarded for further processing by the payment device network system.

3. The method of claim 1, further comprising:
enrolling, with the system server, the VAS apps, wherein enrolling includes certifying the VAS apps, respectively, for compliance with one or more security rules,

4. The method of claim 1, wherein the network participants are selected from the groups consisting of an acquirer entity and an issuer entity.

5. The method of claim 1, wherein the transaction request is a payment authorization request received from an acquirer entity via the payment device network system.

6. The method of claim 1, further comprising:
selecting, by the system server, the one or more data elements of the transaction request for transmission to the VAS app according to the predefined usage criteria.

7. The method of claim 1, wherein the predefined usage criteria specify conditions that qualify a particular transaction for processing by the at least one VAS app and specify which data elements of a transaction request that the VAS app is provided access to in connection with the processing by the VAS app.

8. A system for processing transactions carried out over a payment device network system and selectively facilitating supplemental processing of qualifying transactions by third-party value adding service applications, the system comprising:
at least one processor of a payment device network system server;
a communication interface for establishing electronic communication between the payment device network system server and a plurality of payment network participant systems and between the payment device network system server and a plurality of third-party value adding service applications (VAS apps);
a database that is accessible by the payment device network system server, wherein the database includes predefined usage criteria specifying conditions for using respective VAS apps to process transactions on behalf of respective payment network participants;
a computer readable storage medium that is accessible by the at least one processor and includes software modules in the form of executable instructions; and
the software modules comprising:
a transaction monitoring module that, when executed by the at least one processor, configures the payment device network system server to receive transaction requests concerning a transaction, and determine whether the transaction request is a qualifying transaction according to the predefined usage criteria;
a transaction routing module that, when executed by the at least one processor, configures the payment device network system server to:
in response to determining that the transaction request is a qualifying transaction, transmit one or more data elements of the transaction request to at least one VAS app for supplemental processing, and receive, from the at least one VAS app, a result of the supplemental processing of the qualifying transaction request, and
forward the transaction request for further processing of the transaction via the payment device network system in accordance with a default payment processing workflow, wherein the forwarded transaction request comprises the received qualifying transaction request and any result of supplemental processing of transaction request by the at least one VAS app.

9. The system of claim 8, further comprising a transaction processing module that, when executed by the at least one processor, configures the payment device network system server to enrich the transaction request associated with the qualifying transaction according to the result received from the at least one VAS app, and wherein the enriched transaction request is forwarded for further processing via the payment device network system.

10. The system of claim 8, further comprising an enrollment module that, when executed by the at least one processor, configures the payment device network system server to enroll the VAS apps, wherein enrolling includes certifying the VAS apps, respectively, for compliance with one or more security rules.

11. The system of claim 8, wherein the network participants are selected from the groups consisting of an acquirer entity and an issuer entity.

12. The system of claim 8, wherein the transaction request is a payment authorization request received from an acquirer entity via the payment device network system.

13. The system of claim 8, wherein the transaction routing module further configures the payment device network system server to select the one or more data elements of the transaction request for transmission to the VAS app according to the predefined usage criteria.

14. The system of claim 13, wherein the predefined usage criteria specify conditions that qualify a particular transaction for processing by the at least one VAS app and specify which data elements of the transaction request that the VAS app is provided access to in connection with the processing by the VAS app.

15. A non-transitory computer readable medium encoded with computer executable instructions, which, when executed by a server computing device within a payment device network system, configure the system server computing device to:
provide, a communication connection between the system server and respective VAS apps for transmitting transaction messages between the payment device network system and the VAS apps, and a communication connection between the system server and a plurality of payment network participant systems for transmitting transaction messages between the payment device network system and the network participants;
store, in a database that is accessible to the system server, predefined usage criteria specifying conditions for performing supplemental processing of transactions on behalf of respective network participants using respective VAS apps;
receive a transaction request concerning a transaction associated with at least one network participant;
determine, according to the transaction request and the predefined usage criteria, whether the transaction is qualified for supplemental processing by at least one of the VAS apps;
in response to determining that the transaction is a qualified for supplemental processing by the at least one VAS app,
transmit one or more data elements of the transaction request to the at least one VAS app for supplemental processing of the qualifying transaction, and
receive, from the at least one VAS app, a result of the supplemental processing by the at least one VAS app; and
forward the transaction request for further processing via the payment device network system in accordance with a default payment processing workflow, wherein the forwarded transaction request comprises the received transaction request and any result of pre-processing the transaction request by the at least one VAS app.
